(19) United States
(12) Patent Application Publication
(10) Pub. No.: US 2004/0062260 A1
(43) Pub. Date: Apr. 1, 2004

(54) Multi-level jitter control

(76) Inventors: Anthony E. Raetz, Menlo Park, CA (US); Yanghua Liu, San Jose, CA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/262,464

(22) Filed: Sep. 30, 2002

(51) Int. Cl. H04L 12/28; H04L 12/66

(52) U.S. Cl. 370/412; 370/352

(57) ABSTRACT

Multi-level Jitter Control includes a system and operational methods for distributing jitter buffers among two or more subsystems of a system on a chip “SOC”. In one embodiment, an integrated circuit includes a first processor equipped to receive audio data, perform a first level of jitter buffer control on the audio data, and transmit the audio data to a second processor of the integrated circuit, and a second processor equipped to perform a second level of jitter buffer control on the audio data prior to the audio data being played out.

### BACKGROUND OF THE INVENTION

1. Field of the Invention

The present invention relates to the field of integrated circuits. More specifically, the present invention relates to multi-staged jitter control.

2. Background Information

With advances in integrated circuit, microprocessor, networking and communication technologies, an increasing number of devices, in particular, digital computing devices, are being networked together. Devices are often first coupled to a local area network, such as an Ethernet based office/home network. In turn, the local area networks are interconnected together through wide area networks, such as SONET networks, ATM networks, Frame Relays, and the like. Historically, data communication protocols specified the requirements of local/regional area networks, whereas telecommunication protocols specified the requirements of the regional/wide area networks. However, the rapid growth of the Internet has fueled a convergence between data communication (datacom) and telecommunication (telecom) protocols and requirements.

Voice-Over-IP (VoIP) is a term used to generally describe the delivery of voice and signaling information over digital packet-based networks such as those using the Internet Protocol (IP). One major advantage of such network telephony is the ability to avoid tolls typically charged by the ordinary public switched telephone network (PSTN). Unfortunately, however, packet based networks such as the Internet were never designed to provide telephone service. In IP telephony, a voice conversation is typically digitized, compressed (e.g. using one or more coding/decoding schemes or CODECs), and broken up into audio packets, which are then sent over the Internet. Due to unpredictable latencies and packet loss inherent within packet networks, it is difficult to guarantee a particular quality of service (QOS) level. This is particularly important in voice communications where even as little as a 100 ms delay in the arrival of a packet can be noticeable, and a delay of 250 ms can make a two-way conversation difficult or impossible.

The delay problem is compounded by the need to remove jitter—the variation in arrival time of sequential packets. Various attempts have been made in removing jitter, although the most common method is to buffer the received voice data prior to the data being played out. Typically, the voice data is buffered by a digital signal processor (DSP) of e.g. a voice processing module (VPM), long enough to allow the slowest packets to arrive in time to be played in correct sequence and to allow lost packets to be unnoticeably recovered by retransmission. The sizes of the jitter buffers are often determined based upon a tradeoff made between the amount of data that needs to be buffered and the resources such as memory available to perform the buffering. Unfortunately however, DSPs typically have a small footprint and a relatively small amount of memory, which in turn acts as a channel limiter as to the number of voice channels that can be supported.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of a system-on-a-chip (SOC) including an on-chip bus and a number of subsystems incorporating multi-level jitter buffer facilities of the present invention, in accordance with one embodiment as shown;

FIG. 2 is a block diagram logically illustrating jitter buffer facilities of the present invention in the context of a data transmission process between a first processor subsystem and a second processor subsystem, in accordance with one embodiment;

FIG. 3a is a flow diagram illustrating the operational flow of processor subsystem 110 for transmitting data to another processor subsystem, in accordance with one embodiment of the invention;

FIG. 3b is a flow diagram illustrating the operational flow of processor subsystem 120 for receiving data from another processor subsystem, in accordance with one embodiment of the invention;

FIG. 4 is a block diagram logically illustrating one embodiment of a receive data process, where data is received by the processor subsystem 110 from processor subsystem 120;

FIG. 5 is a flow diagram illustrating the receive data process of FIG. 4, in accordance with one embodiment.

FIG. 6 is a block diagram illustrating SOC 600 with subsystems 602a-602d incorporated with data transfer units (DTUs) to facilitate inter-subsystem communication on prioritized on-chip bus 604, is shown in accordance with one embodiment;

FIG. 7 illustrates DTU 708* in further details, in accordance with one embodiment; and

FIG. 8 illustrates an exemplary data organization suitable for use to store various SOC and processor subsystem related data to practice the present invention, in accordance with one embodiment.

### DETAILED DESCRIPTION OF THE INVENTION

The present invention includes a system and operational methods for distributing jitter buffers among two or more subsystems of a system on a chip “SOC”. In the following description, various features and arrangements will be described, to provide a thorough understanding of the present invention. However, the present invention may be practiced without some of the specific details or with alternate features/arrangement. In other instances, well-known features are omitted or simplified in order not to obscure the present invention.

The description to follow repeatedly uses the phrase “in one embodiment”, which ordinarily does not refer to the same embodiment, although it may. The terms “comprising”, “having”, “including” and the like, as used in the present application, including in the claims, are synonymous.

### Overview

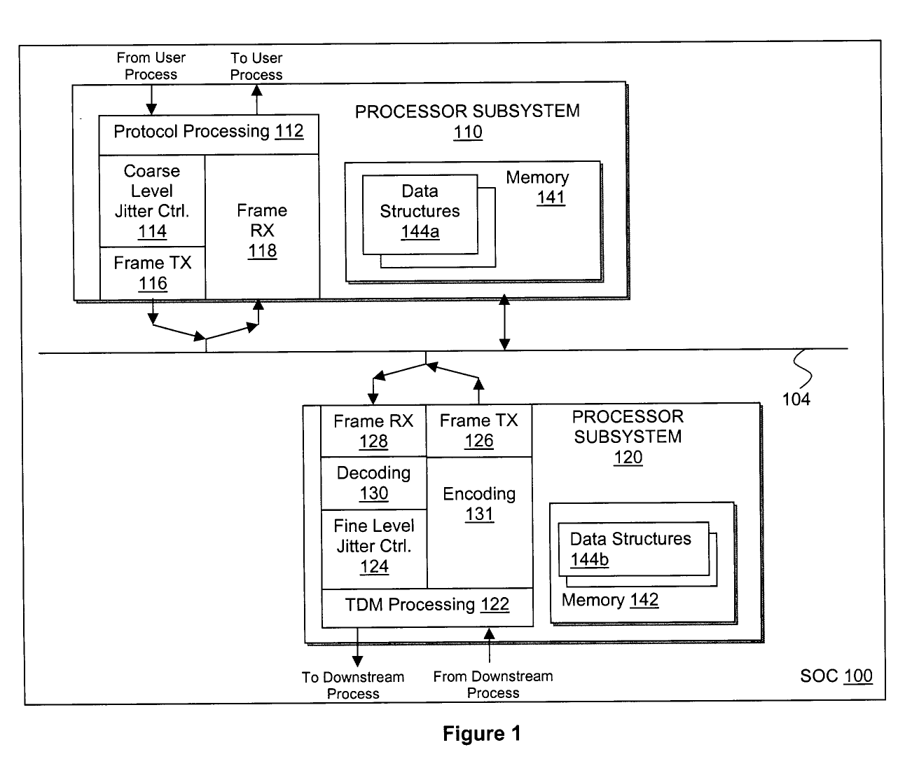

FIG. 1 illustrates an overview of a system-on-a-chip (SOC) including an on-chip bus and a number of subsystems incorporating multi-level jitter buffer facilities of the present invention, in accordance with one embodiment as shown. As illustrated for the embodiment, SOC 100 includes a first processor subsystem 110 including memory 141, and a second processor subsystem 120 including memory 142, coupled to each other by way of high-speed prioritized on-chip bus 104. In accordance with one embodiment of the invention, processor subsystem 110 receives packetized data such as encoded speech or speech band limited data from one or more user processes (e.g. one or more existing time division multiplex voice or voice band data applications), performs a first level of jitter buffer control on the packetized data, and subsequently transmits the data via on-chip bus 104 to processor subsystem 120. Upon receiving the data, processor subsystem 120 decodes the data (if encoded) and performs a second level of jitter buffer control on the data before playing the data out to one or more downstream processes. In one embodiment, processor subsystem 110 represents a general-purpose processing module while processor subsystem 120 represents a voice-processing module (VPM) containing one or more digital signal processors.

In accordance with the illustrated embodiment, processor subsystem 110 includes protocol-processing block 112 for receiving and transmitting packetized data, coarse level jitter control block 114 to perform packet ordering and jitter control in accordance with one embodiment of the invention, as well as frame transmit block 116 to transmit user process data to processor subsystem 120, and frame receive block 118 to receive downstream process data from processor subsystem 120. In one embodiment, protocol-processing block 112 includes one or more network protocol processing layers such as, but not limited to, an Ethernet layer, an Internet Protocol (IP) layer, a User Data Protocol (UDP) layer, and a Real-Time Protocol (RTP) layer, to facilitate processing and transmission of voice data, and in particular, voice-over-packet (VoP) or voice-over-IP (VOIP) data.

Processor subsystem 110 further includes memory 141, which represents a random access memory such as synchronous dynamic random access memory (DRAM) that is coupled to on-chip bus 104 to provide various data structures (144a) representing such things as transmit buffers, jitter buffers, and data receive buffers, in accordance with one embodiment of the invention. Data transmit buffers are used to temporarily store one or more user process data packets for transmission to processor subsystem 120. Depending upon the particular user process involved, user packets received from one or more user processes can contain one or more frames of data associated with a given type of CODEC. Accordingly, the data transmit buffers can be used to identify a CODEC type associated with the received user data and to determine one or more CODEC frames worth of data based e.g. at least in part upon the particular CODEC type employed for a given packet. The jitter buffers represent one or more buffer structures within memory 141 used to temporarily store or buffer multiple frames of received user data to facilitate packet ordering and e.g. to compensate for the delay effects of network packet transmission. The data receive buffers represent one or more buffer structures associated with a given DS0 to which processor subsystem 120 will transfer received downstream process data based upon e.g. an index into memory 141 maintained by processor subsystem 120.

Processor subsystem 120 includes frame receive block 128 for processing data received from processor subsystem 110 (e.g. via on-chip bus 104), frame transmit block 126 for placing processed data onto on-chip bus 104 for transmission to e.g. processor subsystem 110 and/or memory 141, decoding block 130 for decoding encoded data received from processor subsystem 110, encoding block 131 for encoding data to be transmitted to processor subsystem 110, and time division multiplexing (TDM) block 122 to place voice band speech or data onto an appropriate TDM highway, for the benefit of one or more downstream processes and to receive voice band speech or data from a downstream process for the benefit of one or more user processes. Additionally, processor subsystem 120 includes memory 142, which represents a volatile memory used to temporarily store one or more data structures (144b) including structures representing one or more playout ring-buffers for use in association with fine level jitter control block 124.

In accordance with the teachings of the present invention, processor subsystem 120 is equipped with fine level jitter control block 124 to provide additional jitter buffer control facilities to SOC 100 so as to compliment the coarse level jitter buffer control functions provided by processor subsystem 110. As will be described in further detail below, in one embodiment of the invention, fine level jitter buffer control block 124 utilizes one or more playout ring-buffers, each associated with a particular decoder channel to determine whether playout of voice/speech data is to occur at a nominal rate, be sped up to handle a potential buffer over-run condition, or to repeat data in the playout ring-buffer to mask a data under-run condition.

### Data Transmit Process

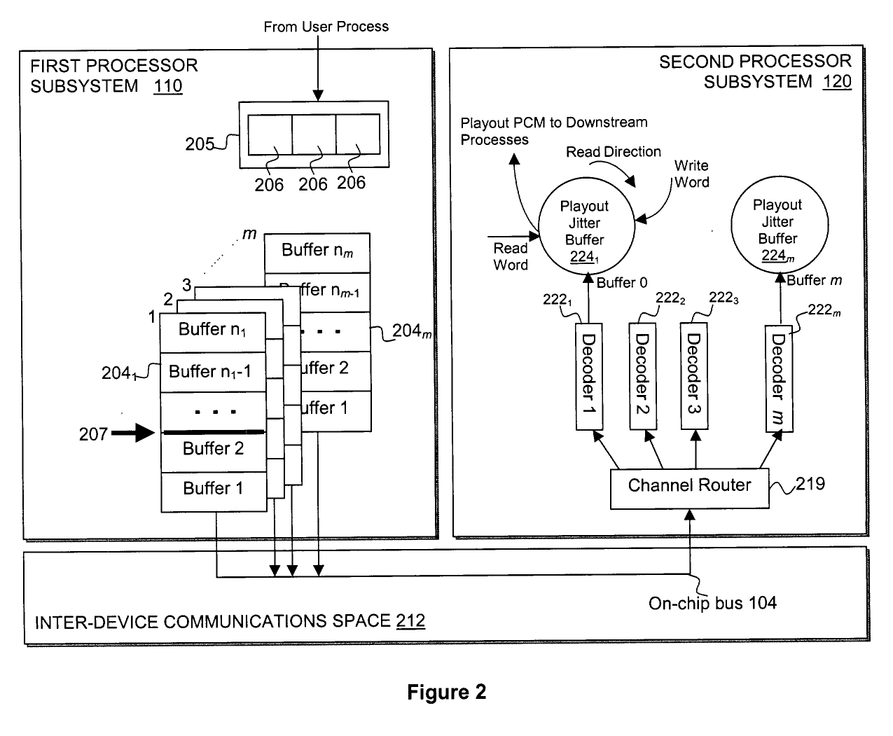

FIG. 2 is a block diagram logically illustrating jitter buffer facilities of the present invention in the context of a data transmission process between a first processor subsystem and a second processor subsystem, in accordance with one embodiment. In the illustrated embodiment, processor subsystem 110 includes jitter buffers 204₁-204ₘ (collectively jitter buffers 204*). Although in the present embodiment jitter buffers 204* are shown to be physically located in memory 141, jitter buffers 204* are nonetheless dynamically managed by processor subsystem 110 and may be physically located external to processor subsystem 110 and/or distributed among multiple processor subsystems, without departing from the spirit and scope of the present invention.

Processor subsystem 120 includes m decoders (i.e. 222₁-222_{M}—collectively decoders 222*) to decode encoded data packets received from processor subsystem 110 (as well as other subsystems), and channel router 219 to route the data packets to an appropriate one of decoders 222* based e.g. upon the particular coding scheme (i.e. CODEC) used to encode a given data packet (as determined e.g. by a CODEC identifier prepended/appended to the data packet by processor subsystem 110). Each of decoders 222* is further associated with a corresponding one of playout jitter buffers 224₁-224ₘ (collectively playout jitter buffers 224*), which temporarily stores decoded data to further mitigate packet jitter. In one embodiment, processor subsystem 120 determines (e.g. based upon control information received from processor subsystem 110 and the state of one or more jitter buffers 224*) whether, for example, playout to downstream processes should occur at a nominal rate, be sped up to handle a potential buffer over-run condition, or repeat data in the playout jitter buffer to mask a data under-run condition. In one embodiment, each playout jitter buffer 224* includes a write pointer to indicate a location at which the corresponding decoder should store the next decoded data word, and a read pointer to indicate a location from which a data word is to be “played out” or otherwise decimated. In the event any of playout jitter buffers 224* needs to mask a data under-run condition based upon control information received from processor subsystem 110 via on-chip bus 104, the corresponding playout jitter buffer can go back in time in the playout jitter buffer and replay the data corresponding to the “new” time, render silence while keeping track where the read pointer should be in time so when the data does appear, it is stored in the correct place to start decimating the data, and so forth. In one embodiment, the control information is received by processor subsystem 120 via on-chip bus 104 at the same time a CODEC data frame is being transmitted from processor subsystem 110 to processor subsystem 120 (i.e. in parallel).

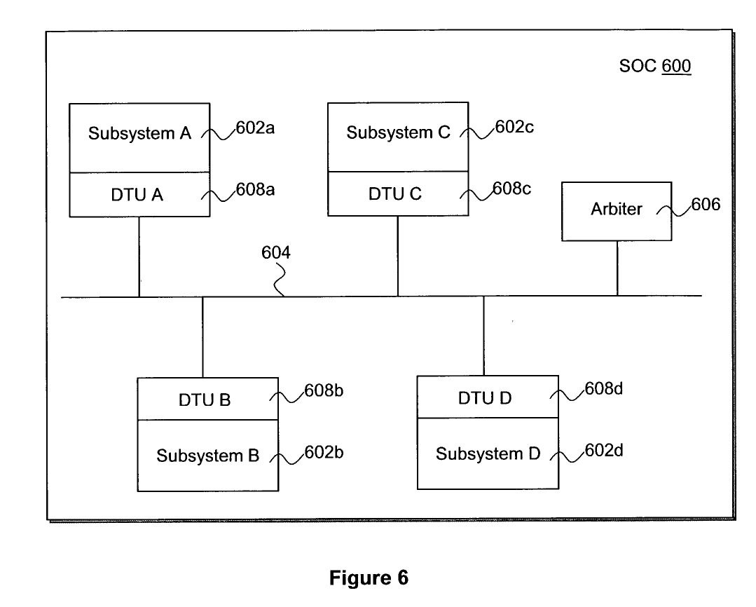

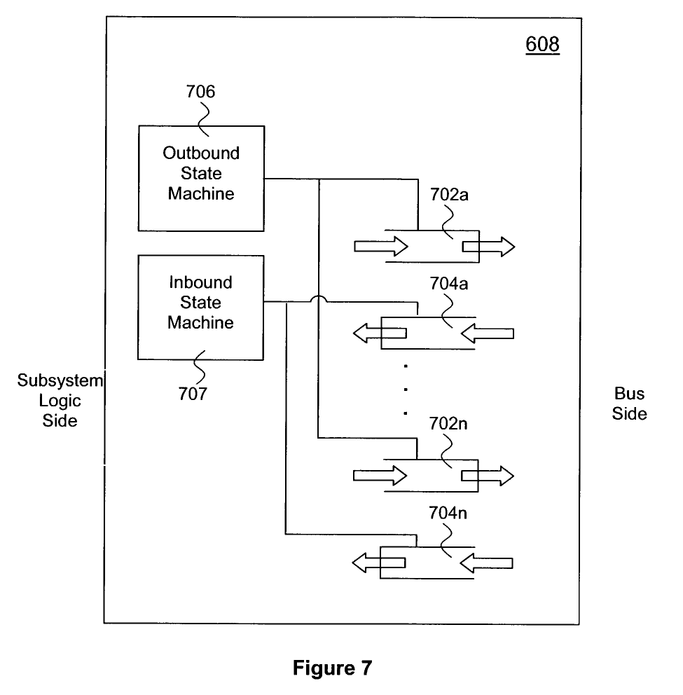

Inter-device communications space includes on-chip bus 104 and facilitates inter-subsystem communication between e.g. processor subsystem 110 and processor subsystem 120. In one embodiment, on-chip bus 104 provides the transmit path for speech/voice data (including CODEC data) subsystems of SOC 100 via data queues associated with each corresponding subsystem as described in further detail below with respect to FIGS. 6 and 7.

As illustrated in FIG. 2, processor subsystem 110 receives a packet of user data 205 containing one or more frames of data associated with a one of a multiplicity of CODECs (i.e. CODEC frames 206). Accordingly, depending at least in part upon the nature of the CODEC utilized and the number of CODEC frames 206 contained within user frame 205, the size of jitter buffers 204* (in terms of memory consumption) is configured on a “per-channel” basis. For example, Table 1 illustrates example CODECs and their corresponding minimum frame sizes for which jitter buffers 204* can be configured to store. In one embodiment, each CODEC frame of data contains a minimum of 5 ms of voice band information, however, in other embodiments the minimum amount of voice band information may be higher or lower. Furthermore, in one embodiment, processor subsystem 110 supports 32 discrete channels and each jitter buffer 204* ranges from 2 to 16 user frames of data deep. However, in other embodiments the user jitter buffer frame depth upper and lower bounds may vary depending upon e.g. the limitations of the physical transport mechanism, the amount of acceptable end-to-end transmission delay and the amount of SDRAM associated with processor subsystem 110.

In one embodiment, data frames received out or order (e.g. with respect to a given packet flow) are stored within jitter buffers 204* in a sequentially ordered fashion (i.e. ordered with respect to the particular packet flow). Thereafter, the buffered CODEC frames may be read out of jitter buffers 204* and transmitted to processor subsystem 120 based upon the positional order the frames are stored within jitter buffers 204*. In one embodiment, processor subsystem 110 prepends (or appends) a channel identifier to each frame to indicate to channel router 219 which decoder should be used to decoder the frame.

TABLE 1

| | | |
|---|---|---|
| G.711 A and u-Law | 5 ms per frame | 20 Bytes of speech data |
| G.726 ADPCM 32 Kbps | 5 ms per frame | 10 Bytes of speech data |
| G.729 A/B | 10 ms per frame | 10 Bytes of speech data |
| G.723.1 6.3 Kbps | 30 ms per frame | 23.625 Bytes of speech data |
| | | +.375 bytes of padding |
| G.723.1 5.3 Kbps | 30 ms per frame | 23.625 Bytes of speech data |
| | | +.125 bytes of padding |

In one embodiment of the invention, an intermediate buffer threshold level is defined within one or more of jitter buffers 204* indicating an amount of audio data (e.g. speech/voice) that can be stored within the associated jitter buffer(s) before the contents of the jitter buffer(s) begin to be transmitted to the second processor. For example, in FIG. 2 the intermediate buffer threshold level for jitter buffer 204₁ is indicated by arrow 207 and corresponds to two user frames. That is, after two user frames of data have been stored within jitter buffer 204₁, processor subsystem 110 begins to transmit the data stored within jitter buffer 204₁ to processor subsystem 120 via on-chip bus 104. When processor subsystem 110 determines that data needs to be transmitted to processor subsystem 120 (e.g. as determined by a defined intermediate threshold level), processor subsystem 110 transmits the data in CODEC-sized frames. Since user frame 205 may contain multiple CODEC frames 206, in one embodiment processor subsystem 110 provides processor subsystem 120, or more particularly a corresponding coder within processor subsystem 120, with a CODEC frame's worth of data. This is because voice coders typically operate with frame sizes that are native to the particular CODEC used. Accordingly, by processor subsystem 110 transmitting CODEC-specific sized frames to a selected one of decoders 222*, resulting pulse code modulated (PCM) data is obtained, which is then stored in a corresponding one of playout jitter buffers 224*.

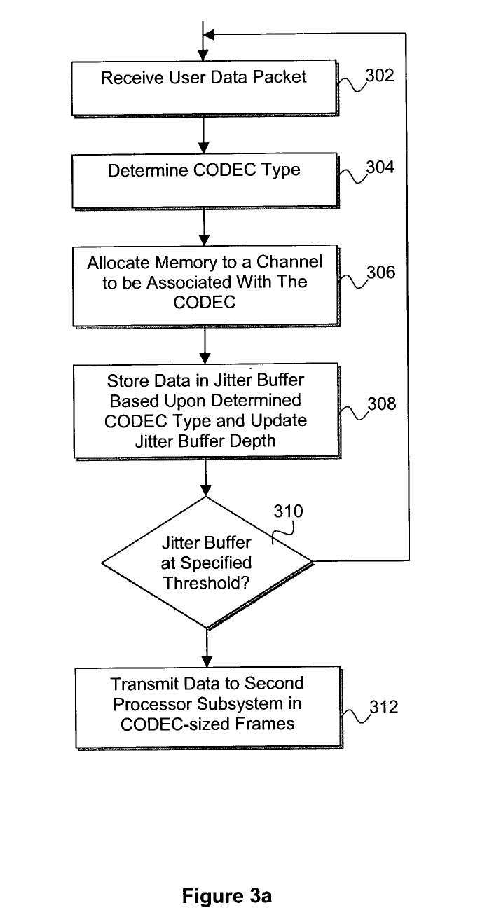

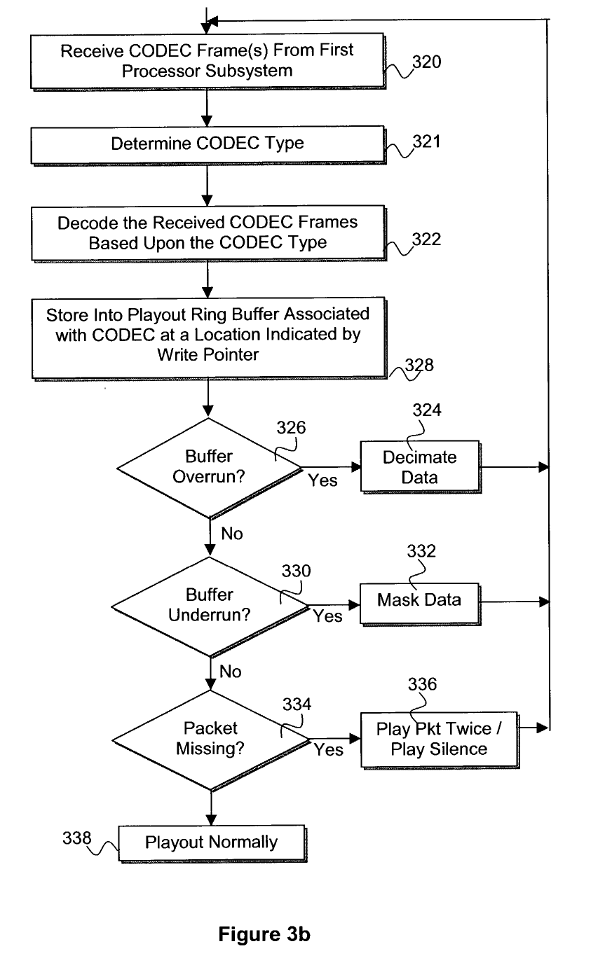

FIG. 3a is a flow diagram illustrating the operational flow of processor subsystem 110 for transmitting data to another processor subsystem, in accordance with one embodiment of the invention. As shown, the process begins with a user data packet being received (block 302). Thereafter, the CODEC associated with the user data is determined (block 304) and memory is allocated to a channel which his to be associated with the CODEC (block 306). Once the memory has been allocated, one or more jitter buffers are created and the data is then stored within a jitter buffer determined based at least in part upon the CODEC type (block 308). A determination is then made as to whether any jitter buffers have reached a specified threshold (block 310). If not, the process begins again and waits for another user data packet to arrive. However, if a specified threshold is reached in one or more of the jitter buffers, the data stored within those jitter buffers is transmitted to a second processing subsystem (block 312).

FIG. 3b is a flow diagram illustrating the operational flow of processor subsystem 120 for receiving data from another processor subsystem, in accordance with one embodiment of the invention. As illustrated, the process begins with processor subsystem 120 receiving a CODEC-sized data frame from the first processor system (block 320), and determining the type of CODEC associated with the data (block 321). In one embodiment, the CODEC type is identified based upon one or more identifiers prepended/appended to the data by e.g. the first processor subsystem prior to transmission. However, one or more other techniques known in the art for identifying CODECs may instead be used. Once the appropriate CODEC is identified, the CODEC frames are decoded based upon the determined CODEC type (block 322). The decoded frames are then each stored into a playout ring-buffer associated with the determined CODEC at a location indicated by a write pointer (block 324). If processor subsystem 120 is notified (by e.g. processor subsystem 110) as to a buffer overrun condition occurring in jitter buffers of processor subsystem 110, for example (block 326), processor subsystem 120 decimates the data in any of a number of possible ways (block 328). If processor subsystem 120 is not notified as to the occurrence of a buffer overrun condition (block 326), but is notified as to the occurrence of a buffer underrun condition (block 330), processor subsystem 120 proceeds to mask the data (332). Furthermore, if processor subsystem 120 is not notified as to the occurrence of a buffer underrun condition, but detects that a packet is missing (i.e. a packet has not arrived before the packet that follows it is to be played out by processor subsystem 102) (block 334), processor subsystem 102 either plays the packet following the lost packet twice or plays silence in place if the missing packet (block 336). On the other hand, if processor subsystem 120 is not notified as to the occurrence of or doesn't detect a buffer overrun, underrun, or packet-missing condition, playout continues at a nominal rate (block 338).

For example, upon processor subsystem 110 detecting a packet loss or delay in a received data flow such that a buffer underrun condition occurs, processor subsystem 110 might indicate such an underrun condition to processor subsystem 120 via state/control information. In response, processor subsystem 120 may mask at least a portion of the data by e.g. going back in time in the playout ring-buffer and replaying one or more frames or rendering silence while keeping track of where the read and write pointers should be in time so when the data does show up, it is in the correct place to start the decimation processes. Once the missing or slow to arrive data actually does arrive at processor subsystem 110 (e.g. milliseconds later), it may arrive rapidly causing a buffer overrun condition to occur. Accordingly, processor subsystem 110 notifies processor subsystem 120 of such a case via state/control information and speeds delivery of the data to processor subsystem 120. In response, processor subsystem 120 would begin to decimate the data in any of a number of ways including dropping the data completely, playing the data out at a faster rate so as to regain proper timing.

### Data Receive Process

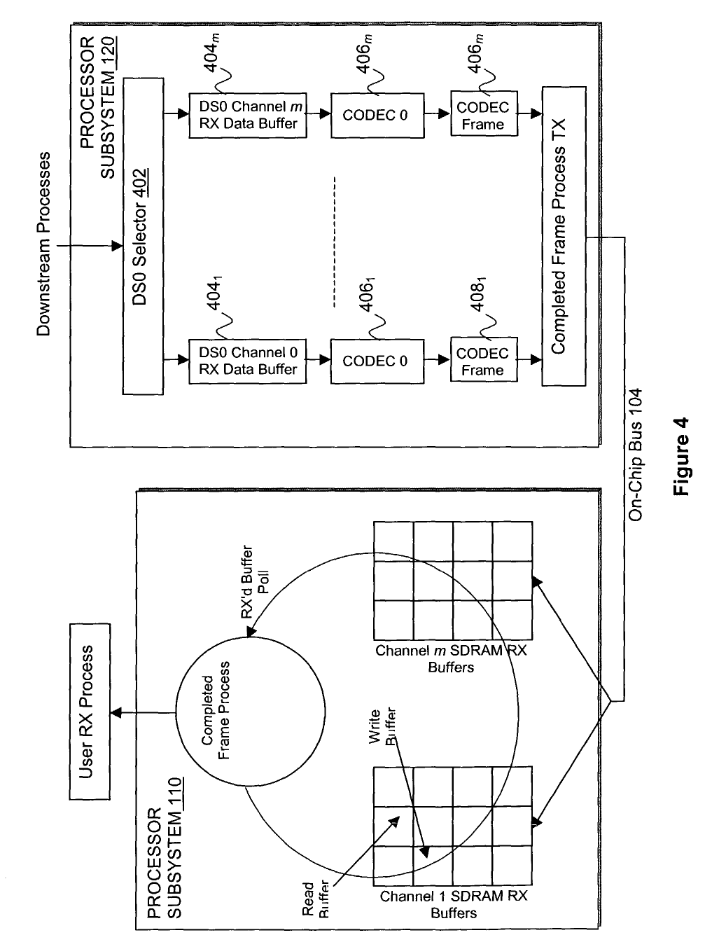

FIG. 4 is a block diagram logically illustrating one embodiment of a receive data process, where data is received by the processor subsystem 110 from processor subsystem 120. As shown, processor subsystem 120 receives data from one or more downstream processes via e.g. a TDM highway, one or more on-chip buses such as on-chip bus 104. DS0 selector 402 then associates (e.g. through a cross-connect block function (not shown)) an input DS0 channel with an appropriate DS0 decoder channel 404₁-404ₘ (hereinafter 404*) as shown. Depending upon the CODEC to be applied to the input DS0, a number of PCM bytes may have to be buffered. In one embodiment, one PCM byte is buffered for PCM and ADPCM data, whereas 10 ms and 30 ms worth of data is respectively buffered for G.720 and G.723.1 coders. The data is then fed into a corresponding one of the coders (e.g. CODEC 406*), which outputs frames of data associated with that coder (e.g. CODEC output frame 408*). Output frame 408* is then transmitted across on-chip bus 104 via a data queue (to be described below) and stored in memory (such as memory 141) associated with processor subsystem 110. In one embodiment, the locations to be used in the memory are communicated from processor subsystem 110 to processor subsystem 120 at the time a given channel is created/activated. Processor subsystem 120 then uses a write index to subsequently identify such write locations for a given DS0.

When processor subsystem 120 has transferred an appropriate number of CODEC frames to the memory of processor subsystem 110, processor subsystem 120 will set one or more “done” bits within the write buffer. In one embodiment, the appropriate number of CODEC frames is configured dynamically per channel and may e.g. depend on the memory (SDRAM) available in processor subsystem 110 (this is identified by memory 141), the transport protocol maximum number of payload bytes and the packet loading to be placed on the transport load. In one embodiment, CODEC frames are bounded by 1 at the low end and (CODEC FRAMES*BYTES/FRAME)<MAX PAYLOAD BYTES at the high end.

In one embodiment, processor subsystem 120 stores an expected value/codeword in the write buffer to indicate to processor subsystem 110 that the data transfer is complete, while processor subsystem 110 periodically polls the buffer to identify the existence of such a value. In one embodiment, processor subsystem 120 transfers data blindly into the memory of processor subsystem 110, based upon its own write pointer into the write buffers associated with a given DS0. Similarly, in one embodiment, processor subsystem 110 maintains a read pointer to the next buffer to become valid (e.g. as determined by the presence of the expected value/codeword. Thereafter, processor subsystem 110 hands off the buffer indicated by the read pointer to the user receive process for final processing and transmission.

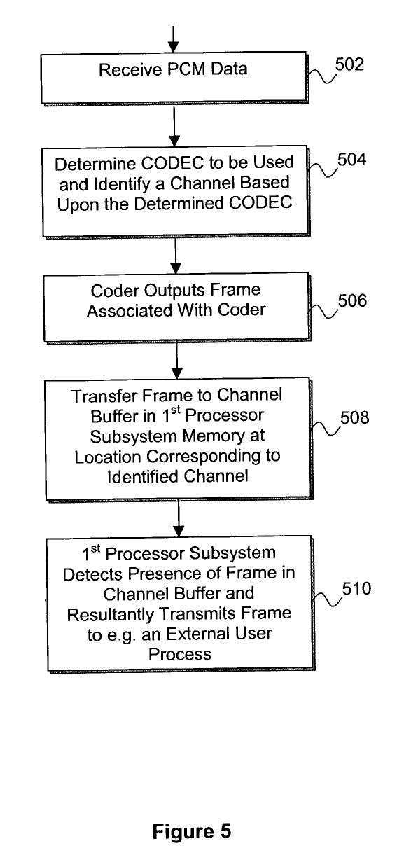

FIG. 5 is a flow diagram illustrating the receive data process of FIG. 4, in accordance with one embodiment. The process begins with PCM data being received from one or more downstream processes (block 502). The CODEC type corresponding to the PCM data is then determined and DS0 selector 402 determines an appropriate channel for the data based upon the CODEC (block 504). A coder associated with the determined CODEC (406₁-406ₘ) then outputs a data frame (408₁-408ₘ) (block 506), which is then transferred to a channel buffer in the memory of processor subsystem 110 at a location corresponding to identified channel (block 508). Processor subsystem 110 then detects the presence of the frame in channel buffer and in turn, transmits the frame to e.g. an external user process.

### Bus Structure

Referring now to FIG. 6, wherein a block diagram illustrating SOC 600 with subsystems 602a-602d incorporated with data transfer units (DTUs) to facilitate inter-subsystem communication on prioritized on-chip bus 604, is shown in accordance with one embodiment. As illustrated, for the embodiment, SOC 600 includes on-chip bus 604 and subsystems 602a-602d coupled to each other through bus 604. Moreover, each of subsystems 602a-602d includes data transfer unit or interface 608a-608d, correspondingly coupling the subsystems 602a-602d to bus 604. SOC 600 also includes arbiter 606, which is also coupled to bus 604.

In the present embodiment, bus 604 includes a number of sets of request lines (one set per subsystem), a number of sets of grant lines (one set per subsystem), and a number of shared control and data/address lines. Included among the shared control lines is a first control line for a subsystem granted access to the bus (grantee subsystem, also referred to as the master subsystem) to assert a control signal to denote the beginning of a transaction cycle, and to de-assert the control signal to denote the end of the transaction cycle; and a second control line for a subsystem addressed by the grantee/master subsystem (also referred to as the slave subsystem) to assert a control signal to inform the grantee/master subsystem that the addressee/slave subsystem is busy (also referred to as “re-trying” the master system).

As a result of the facilities advantageously provided by DTU 608a-608d, and the teachings incorporated in subsystem 602a-602d, subsystems 602a-602d are able to flexibly communicate and cooperate with each other, allowing subsystems 602a-602d to handle a wide range of different functions having different needs. More specifically, as will be described in more detail below, in one embodiment, subsystems 602a-602d communicate with each other via transactions conducted across bus 604. Subsystems 602a-602d, by virtue of the facilities advantageously provided by DTU 608a-608d, are able to locally prioritize the order in which its transactions are to be serviced by the corresponding DTU 608a-608d to arbitrate for access to bus 604. Further, in one embodiment, by virtue of the architecture of the transactions, subsystems 602a-602d are also able to flexibly control the priorities on which the corresponding DTU 608a-608d are to use to arbitrate for bus 604 with other contending transactions of other subsystems 602a-602d.

Arbiter 606 is employed to arbitrate access to bus 604. That is, arbiter 606 is employed to determine which of the contending transactions on whose behalf the DTU 608a-608d are requesting for access (through e.g. the request lines of the earlier described embodiment), are to be granted access to bus 604 (through e.g. the grant lines of the earlier described embodiment).

SOC 600 is intended to represent a broad range of SOC, including multi-service ASIC. In particular, in various embodiments, subsystems 602a-602d may be one or more of a memory controller, a security engine, a voice processor, a collection of peripheral device controllers, a framer processor, and a network media access controller. In one embodiment, at least one of subsystems 602a-602d represents processor subsystem 110, and at least one of remaining subsystems 602a-602d represents processor subsystem 120. Moreover, by virtue of the advantageous employment of DTU 608a-608d to interface subsystems 602a-602d to on-chip bus 604, with DTU 608a-608d and on-chip bus operating on the same clock speed, the core logic of subsystems 602a-602d, such as jitter buffer control logic 114 and 124 of FIG. 1, may operate in different clock speeds, including clock speeds that are different from the clock speed of non-chip bus 604 and DTU 608a-608d. In one embodiment, one or more subsystems 602a-602d may be a multi-function subsystems, in particular, with the functions identified by identifiers. While for ease of understanding, SOC 600 is illustrated as having four subsystems 602a-602d, in practice, SOC 600 may have more or less subsystems. In particular, by virtue of the advantageous employment of DTU 608a-608d to interface subsystems 602a-602d to on-chip bus 604, zero or more selected ones of subsystems 602a-602d may be removed, while other subsystems 602a-602d may be flexibly added to SOC 600.

Similarly, arbiter 606 may be any one of a number of bus arbiters known in the art. The facilities of DTU 608a-608d will be further described below.

### Data Transfer Units

FIG. 7 illustrates DTU 608* in further details, in accordance with one embodiment. As illustrated, DTU 608* includes a number of pairs of outbound and inbound transaction queues 702* and 704*, one pair each for each priority level. For example, in one embodiment where DTU 608* supports three levels of priority, high, medium and low, DTU 608* includes three pairs of outbound and inbound transaction queues 702a and 704a, 702b and 704b, and 702c and 704c, one each for the high, medium and low priorities. In another embodiment, DTU 608* supports two levels of priority, high and low, DTU 608* includes two pairs of outbound and inbound transaction queues 702a and 704a, and 702b and 704b, one each for the high and low priorities. Of course, in other embodiments, DTU 608* may support more than three levels of priority or less than two levels of priority, i.e. no prioritization.

Additionally, DTU 608* includes outbound transaction queue service state machine 706 and inbound transaction queue service state machine 707, coupled to the transaction queues 702* and 704* as shown. Outbound transaction queue service state machine 706 services, i.e. processes, the transactions placed into the outbound queues 702* in order of the assigned priorities of the queues 702* and 704*, i.e. with the transactions queued in the highest priority queue being serviced first, then the transaction queued in the next highest priority queue next, and so forth.

For each of the transactions being serviced, outbound transaction queue service state machine 706 provides the control signals to the corresponding outbound queue 702* to output on the subsystem's request lines, the included bus arbitration priority of the first header of the “oldest” (in turns of time queued) transaction of the queue 702*, to arbitrate and compete for access to bus 704 with other contending transactions of other subsystems 602*. Upon being granted access to bus 704 (per the state of the subsystem's grant lines), for the embodiment, outbound transaction queue service state machine 706 provides the control signals to the queue 702* to output the remainder of the transaction, e.g. for the earlier described transaction format, the first header, the second header and optionally, the trailing data.

Similarly, inbound transaction queue service state machine 707 provides the control signals to the corresponding inbound queue 702* to claim a transaction on bus 704, if it is determined that the transaction is a new request transaction of the subsystem 602* or a reply transaction to an earlier request transaction of the subsystem 602*. Additionally, in one embodiment, if the claiming of a transaction changes the state of the queue 704* from empty to non-empty, inbound transaction queue service state machine 707 also asserts a “non-empty” signal for the core logic (not shown) of the subsystem 602*.

In due course, the core logic, in view of the “non-empty” signal, requests for the inbound transactions queued. In response, inbound transaction queue service state machine 707 provides the control signals to the highest priority non-empty inbound queue to cause the queue to output the “oldest” (in turns of time queued) transaction of the queue 704*. If all inbound queues 704* become empty after the output of the transaction, inbound transaction queue service state machine 707 de-asserts the “non-empty” signal for the core logic of the subsystem 602*.

Thus, a core logic of a subsystem 602*, such as jitter buffer control logic, is not only able to influence the order its transactions are being granted access to bus 604, relatively to transactions of other subsystems 602*, through specification of the bus arbitration priorities in the transactions' headers, a core logic of a subsystem 602*, by selectively placing transactions into the various outbound queues 602* of its DTU 608*, may also utilize the facilities of DTU 608* to locally prioritize the order in which its transactions are to be serviced to arbitrate for access for bus 604.

Queue pair 602* and 604* may be implemented via any one of a number of “queue” circuitry known in the art. Similarly, state machines 606-607, to be described more fully below, may be implemented using any one of a number programmable or combinatory circuitry known in the art. In one embodiment, assignment of priorities to the queues pairs 602* and 604* are made by programming a configuration register (not shown) of DTU 608*. Likewise, such configuration register may be implemented in any one of a number of known techniques.

### Data Structures

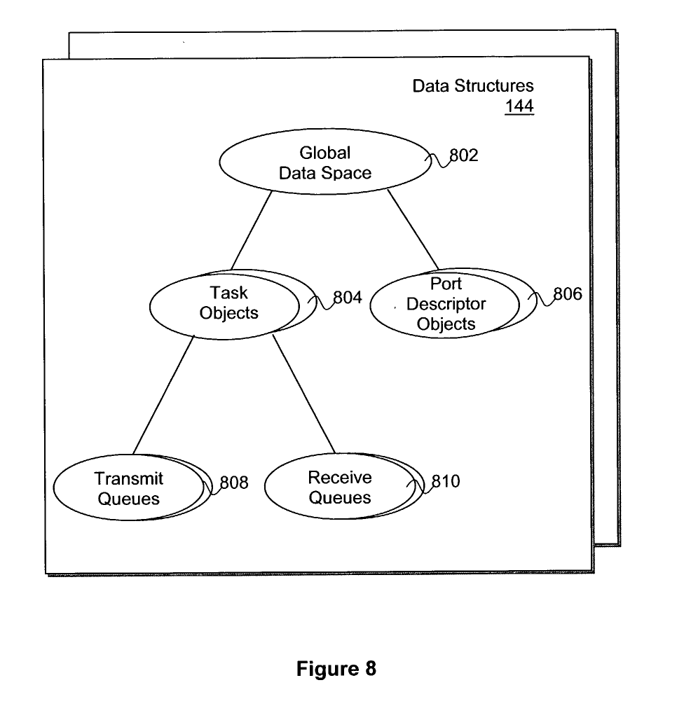

FIG. 8 illustrates an exemplary data organization suitable for use to store various SOC and processor subsystem related data to practice the present invention, in accordance with one embodiment. As illustrated, for the embodiment, data structures 144 employed to facilitate the practice of the present invention are implemented in an object-oriented manner.

Global data space 802 represents a common global data space to store e.g. global configuration and control data variables in association with one or more processor subsystems of SOC 100. Examples of such global variables include but are not limited to TDM interface configurations, WAN port configurations, LAN interface configurations, Security Processor Configuration, and Synchronous/Asynchronous data interface configuration data.

Task objects 804 represent at least a runtime data structure used to keep track of receive and transmit data queues (808, 810) and to control movement of received data to one or more user processes (e.g. from the one or more downstream processes). In one embodiment where RTP is utilized, the runtime structure includes a random seed value, used to generate and/or modify a random number to provide starting sequence numbers and timestamps for RTP transmission of VoIP packets, a handle to a receive/transmit task to facilitate task referencing, as well as receive queue structure 808 and transmit queue structure 810. Receive queue structure 810 represents an array of pointers used to access the data associated with the transfer of data from processor subsystem 120 (e.g. Voice processing module) to memory 141 associated with processor subsystem 110, whereas transmit queue structure 810 represents an array of pointers used to access the data associated with the data transmission from a user process to the receive/transmit task.

In accordance with one embodiment, receive queue structure 808 further includes a variable identifying the number of buffers that have been received from processor subsystem 102 and a variable used to track the private buffers allocated to a given VoP channel. In one embodiment, these private buffers have operating system native memory blocks attached to them to facilitate a zero copy process.

Furthermore, in accordance with one embodiment of the invention, transmit queue structure 810 includes at least a pointer to a transmit data FIFO containing buffers received from a user process, where the head of the FIFO contains the buffer currently being transmitted and the tail of the FIFO contains the latest buffer received from the user process, a variable to track the number of buffers in the transmit data FIFO that are to be transmitted to processor subsystem 120, a variable representing the CODEC sub-frame of the buffer currently being played out that is being transmitted or has been transmitted to processor subsystem 120, and a CODEC frame offset for keeping track of the next CODEC frame to be transmitted to processor subsystem 120.

Port descriptor objects 806 represent one or more data structures containing state and configuration information for a given VoP port. For example, in one embodiment, port descriptor objects 806 contain parameters representing: Whether a port has been enabled for use on processor subsystem 120, the type of CODEC processor subsystem 120 is to apply to speech data, the number of CODEC frames that are to be placed into a buffer before one or more “done” bits are set for that buffer, the jitter buffer depth representing the total memory size required to be allocated for the jitter buffer of processor subsystem 110 (where if more buffers are required than allowed by this parameter, an overflow condition occurs), the jitter buffer threshold level, the transport mode indicating the type of header information to be applied to data received by processor subsystem 110 from processor subsystem 120, and so forth. In one embodiment, a “RAW” transport mode and a “RTP” transport mode are supported. The RAW mode provides completed packets to the user process without prepending or appending any information to the received data, whereas the RTP mode of operation prepends a packet sequence number and a timestamp to the packet in accordance with known RTP conventions.

### Conclusion and Epilogue

Thus, it can be seen from the above descriptions, an improved method and apparatus for controlling jitter has been described. The novel scheme advantageously enables a first level of jitter buffer control to be performed in a first processing subsystem having a larger memory footprint, and a second level of jitter buffer control to be performed in a second processing subsystem having a smaller memory footprint to facilitate increased channel capacity for example. While the present invention has been described in terms of the foregoing embodiments, those skilled in the art will recognize that the invention is not limited to these embodiments. The present invention may be practiced with modification and alteration within the spirit and scope of the appended claims. Thus, the description is to be regarded as illustrative instead of restrictive on the present invention.

What is claimed is:

1. In an integrated circuit, a method of controlling jitter comprising:
receiving audio data at a first processor of the integrated circuit;
performing a first level of jitter buffer control on the audio data by the first processor;
transmitting the audio data to a second processor of the integrated circuit; and
performing a second level of jitter buffer control on the audio data by the second processor prior to the audio data being played out.

2. The method of claim 1, wherein the audio data is encoded in accordance with one of a plurality of coding schemes, the method further comprising:
identifying the audio coding scheme used to encode the audio data;
storing the audio data in a first of a plurality of variable sized jitter buffers based at least in part upon the identified first coding scheme, wherein each of the plurality of variable sized jitter buffers corresponds to a different coding scheme; and
determining a quantum of audio data to be transmitted from the first jitter buffer to the second processor based at least in part upon the identified coding scheme.

3. The method of claim 2, wherein the quantum of audio data corresponds to one or more frames of audio data formed in accordance with the identified audio coding scheme.

4. The method of claim 3, wherein the one or more frames of audio data comprise a minimum of 5 ms of voice band information.

5. The method of claim 2, further comprising:
identifying an intermediate buffer threshold level within the first jitter buffer indicating an amount of audio data that can be stored before the contents of the first jitter buffer are transmitted to the second processor; and
transmitting the audio data to the second processor once the intermediate buffer threshold level has been reached.

6. The method of claim 5, wherein the first jitter buffer is periodically polled to identify whether the intermediate buffer threshold level has been reached.

7. The method of claim 1, further comprising:
transmitting control information and state information to the second processor, wherein the control information indicates one of a plurality of decoders at the second processor to decode the audio data based upon the first coding scheme, and the state information indicates an operating state of the first jitter buffer.

8. The method of claim 7, wherein the state information indicates whether the first jitter buffer is operating in a normal state, a buffer under-run state, a buffer over-run state, and a packet missing state.

9. The method of claim 7, wherein the control information is transmitted to the second processor independent of the audio data.

10. The method of claim 7, wherein the control information is transmitted to the second processor in parallel with the audio data.

11. The method of claim 1, wherein the audio data is encoded based at least in part upon one of a plurality of coding schemes, and wherein performing the second level of jitter buffer control comprises:
receiving the audio data at the second processor;
determining a destination decoder to decode the audio data based at least in part upon the coding schemes used to encode the audio data;
decoding the audio data via the determined destination decoder; and
buffering the decoded audio data in a secondary jitter buffer associated with the destination decoder for an amount of time determined based at least in part upon the depth of the secondary jitter buffer.

12. In an integrated circuit (IC) having a plurality of subsystems, a method for processing voice/audio data comprising:
in a first processor subsystem,
receiving audio data encoded in accordance with one of a plurality of coding schemes;
identifying the coding scheme used to encode the audio data and storing the audio data into a first jitter buffer corresponding to the identified first coding scheme;
transmitting the audio data in addition to command information to a second processor subsystem to facilitate playout of the audio data by the second subsystem;
in a second processor subsystem,
receiving the audio data;
determining one of a plurality of destination decoder channels to decode the audio data based upon the first coding scheme;
decoding the audio data via the determined destination decoder channel; and
buffering the decoded audio data in a secondary jitter buffer associated with the destination decoder based at least in part upon the depth of the secondary jitter buffer and at least a portion of the command information.

13. The method of claim 12, further comprising:
identifying a buffer threshold point within the first jitter buffer indicating an amount of audio data that can be stored within the first jitter buffer before the contents of the first jitter buffer are transmitted to the second processor subsystem; and
wherein the audio data is transmitted to the second processor subsystem upon the buffer threshold point being reached.

14. The method of claim 13, wherein the buffer threshold point corresponds to the midpoint of the first jitter buffer.

15. The method of claim 13, further comprising:
periodically polling the first jitter buffer to determine if the buffer threshold point has been reached.

16. The method of claim 12, further comprising:
associating with the audio data first control information indicating one of a plurality of decoders to be used to decode the audio data, and second control information indicating a current state of the first jitter buffer.

17. The method of claim 12, further comprising:
determining a quantum of audio data to be transmitted from the first jitter buffer to the second processor subsystem based at least in part upon the identified coding scheme.

18. The method of claim 12, wherein the audio data and the command information are transmitted to the second processor subsystem in parallel.

19. An integrated circuit comprising:
a first processor to receive audio data, perform a first level of jitter buffer control on the audio data, and transmit the audio data to a second processor of the integrated circuit; and
a second processor to perform a second level of jitter buffer control on the audio data prior to the audio data being played out.

20. The integrated circuit of claim 19, wherein the audio data is encoded in accordance with one of a plurality of coding schemes and the first processor further
identifies the audio coding scheme used to encode the audio data,
stores the audio data in a first of a plurality of variable sized jitter buffers based at least in part upon the identified first coding scheme, wherein each of the plurality of variable sized jitter buffers corresponds to a different coding scheme, and
determines a quantum of audio data to be transmitted from the first jitter buffer to the second processor based at least in part upon the identified coding scheme.

21. The integrated circuit of claim 20, wherein the quantum of audio data corresponds to one or more frames of audio data formed in accordance with the identified audio coding scheme.

22. The integrated circuit of claim 21, wherein the one or more frames of audio data comprise a minimum of 5 ms of voice band information.

23. The integrated circuit of claim 20, further comprising the first processor identifying an intermediate buffer threshold level within the first jitter buffer indicating an amount of audio data that can be stored before the contents of the first jitter buffer are transmitted to the second processor and transmitting the audio data to the second processor once the intermediate buffer threshold level has been reached.

24. The integrated circuit of claim 23, wherein the first jitter buffer is periodically polled to identify whether the intermediate buffer threshold level has been reached.

25. The integrated circuit of claim 19, further comprising:
the first processor transmitting control information and state information to the second processor, wherein the control information indicates one of a plurality of decoders at the second processor to decode the audio data based upon the first coding scheme, and the state information indicates an operating state of the first jitter buffer.

26. The integrated circuit of claim 25, wherein the state information indicates whether the first jitter buffer is operating in a normal state, a buffer under-run state, a buffer over-run state, and a packet missing state.

27. The integrated circuit of claim 25, wherein the first processor transmits the control information to the second processor independent of the audio data.

28. The integrated circuit of claim 25, wherein the first processor transmits the control information to the second processor in parallel with the audio data.

29. The integrated circuit of claim 19, wherein the audio data is encoded based at least in part upon one of a plurality of coding schemes, and wherein the second processor performs the second level of jitter buffer comprising:
receiving the audio data at the second processor;
determining a destination decoder to decode the audio data based at least in part upon the coding schemes used to encode the audio data;
decoding the audio data via the determined destination decoder; and
buffering the decoded audio data in a secondary jitter buffer associated with the destination decoder for an amount of time determined based at least in part upon the depth of the secondary jitter buffer.

30. An integrated circuit (IC) comprising:
a first processor subsystem to,
receive audio data encoded in accordance with one of a plurality of coding schemes,
identify the coding scheme used to encode the audio data and storing the audio data into a first jitter buffer corresponding to the identified first coding scheme,
transmit the audio data in addition to command information to a second processor subsystem to facilitate playout of the audio data by the second subsystem; and
a second processor subsystem to,
receive the audio data,
determine one of a plurality of destination decoder channels to decode the audio data based upon the first coding scheme,
decode the audio data via the determined destination decoder channel, and
buffer the decoded audio data in a secondary jitter buffer associated with the destination decoder based at least in part upon the depth of the secondary jitter buffer and at least a portion of the command information.

31. The IC of claim 30, wherein the first processor subsystem further
identifies a buffer threshold point within the first jitter buffer indicating an amount of audio data that can be stored within the first jitter buffer before the contents of the first jitter buffer are transmitted to the second processor subsystem; and
transmits the audio data to the second processor subsystem upon the buffer threshold point being reached.

32. The IC of claim 31, wherein the buffer threshold point corresponds to the midpoint of the first jitter buffer.

33. The IC of claim 31, wherein the first processor subsystem periodically polls the first jitter buffer to determine if the buffer threshold point has been reached.

34. The IC of claim 30, wherein the first processor subsystem associates with the audio data, first control information indicating one of a plurality of decoders to be used to decode the audio data, and second control information indicating a current state of the first jitter buffer.

35. The IC of claim 30, wherein the first processor subsystem determines a quantum of audio data to be transmitted from the first jitter buffer to the second processor subsystem based at least in part upon the identified coding scheme.

36. The IC of claim 30, wherein the audio data and the command information are transmitted to the second processor subsystem in parallel.
